(19) United States
(12) Patent Application Publication
(10) Pub. No.: US 2026/0310428 A1
(43) Pub. Date: Oct. 8, 2026

(54) Identifying Coding Patterns via a Control Flow Graph

(71) Applicant: Dell Products L.P., Round Rock, TX (US)

(72) Inventors: Andrea Roggerone, Dublin (IE); Mauro Silva, Passage West (IE); Brian Rochford, Ovens (IE); Steven Soumpholphakdy, Austin, TX (US)

(21) Appl. No.: 19/169,811

(22) Filed: Apr. 3, 2025

(51) Int. Cl. G06F 8/41; G06F 16/901; G06F 21/57

(52) U.S. Cl. CPC G06F 8/433; G06F 8/4435; G06F 16/9024; G06F 21/577

(57) ABSTRACT

A system can create a dependency graph that represents dependencies within computer code. The system can generate respective control flow graphs for respective code blocks of the computer code that are stored in the respective files. The system can for the respective files that correspond to the respective control flow graphs, associate the respective control flow graphs with respective nodes that correspond to the respective files. The system can create order embeddings from the dependency graph. The system can store the order embeddings in a graph database. The system can, based on receiving an inquiry associated with a user account regarding the computer code, query the graph database with a query based on the inquiry to produce an output that indicates a coding pattern similarity. The system can prompt a large language model with the coding pattern similarity and the inquiry to produce an answer to the inquiry.

### BACKGROUND

Software code can contain coding patterns.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can create a dependency graph that represents dependencies within computer code, wherein nodes of the dependency graph represent files of the computer code, and wherein edges of the dependency graph represent respective relationships between respective files of the files. The system can generate respective control flow graphs for respective code blocks of the computer code that are stored in the respective files. The system can for the respective files that correspond to the respective control flow graphs, associate the respective control flow graphs with respective nodes of the nodes that correspond to the respective files. The system can create order embeddings from the dependency graph, wherein the order embeddings preserve an order of the respective control flow graphs. The system can store the order embeddings in a graph database that stores the dependency graph. The system can, based on receiving an inquiry associated with a user account regarding the computer code, query the graph database with a query based on the inquiry to produce an output that indicates a coding pattern similarity. The system can prompt a large language model with the coding pattern similarity and the inquiry to produce an answer to the inquiry. The system can make the answer to the inquiry available via the user account.

An example method can comprise creating, by a system comprising at least one processor, a dependency graph that represents dependencies within computer code, wherein nodes of the dependency graph represent files of the computer code, and wherein edges of the dependency graph represent respective relationships between respective files of the files. The method can further comprise associating, by the system, respective control flow graphs with respective nodes of the nodes that correspond to the respective files that correspond to the respective control flow graphs, wherein the respective control flow graphs correspond to respective code blocks of the computer code that are stored in the respective files. The method can further comprise storing, by the system, order embeddings in a graph database that stores the dependency graph, wherein the order embeddings are based on the dependency graph, and wherein the order embeddings preserve an order of the respective control flow graph. The method can further comprise responding, by the system, to an inquiry associated with a user account regarding the computer code with a response that comprises an output of a retrieval-augmented generation system that comprises the graph database and a large language model.

An example non-transitory computer-readable medium can comprise instructions that, in response to execution, cause a system comprising a processor to perform operations. These operations can comprise creating a dependency graph from computer code, wherein nodes of the dependency graph correspond to files of the computer code. These operations can further comprise associating respective control flow graphs of the respective files with respective nodes of the nodes, wherein the respective control flow graphs correspond to respective code blocks of the computer code. These operations can further comprise storing order embeddings in a graph database that stores the dependency graph, wherein the order embeddings are based on the dependency graph. These operations can further comprise responding to an inquiry associated with a user account regarding the computer code with a response that comprises an output of a retrieval-augmented generation system that comprises the graph database and a large language model.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate identifying coding patterns via a control flow graph, in accordance with an embodiment of this disclosure;

FIG. 2 illustrates an example of an abstract syntax tree and a control flow graph, and that can facilitate identifying coding patterns via a control flow graph, in accordance with an embodiment of this disclosure;

FIG. 3 illustrates an example of an attribute dependency graph and a control flow graph, and that can facilitate identifying coding patterns via a control flow graph, in accordance with an embodiment of this disclosure;

FIG. 4 illustrates an example process flow that can facilitate identifying coding patterns via a control flow graph, in accordance with an embodiment of this disclosure;

FIG. 5 illustrates an example that can facilitate identifying coding patterns via a control flow graph, in accordance with an embodiment of this disclosure;

FIG. 6 illustrates another example that can facilitate identifying coding patterns via a control flow graph, in accordance with an embodiment of this disclosure;

FIG. 7 illustrates another example that can facilitate identifying coding patterns via a control flow graph, in accordance with an embodiment of this disclosure;

FIG. 8 illustrates another example that can facilitate identifying coding patterns via a control flow graph, in accordance with an embodiment of this disclosure;

FIG. 9 illustrates another example process flow that can facilitate identifying coding patterns via a control flow graph, in accordance with an embodiment of this disclosure;

FIG. 10 illustrates another example process flow that can facilitate identifying coding patterns via a control flow graph, in accordance with an embodiment of this disclosure;

FIG. 11 illustrates another example process flow that can facilitate identifying coding patterns via a control flow graph, in accordance with an embodiment of this disclosure; and

FIG. 12 illustrates an example block diagram of a computer operable to execute an embodiment of this disclosure.

### DETAILED DESCRIPTION

### Overview

The present techniques generally relate to programming language processing (PLP), which applies machine learning (ML) techniques to enhance processes and tasks related to programming languages.

Maintaining applications with a large codebase can present challenges. It can be that applications must be allowed to evolve at a reasonable pace to maintain any market advantages. To enable this pace of evolution, it can be that code must not be overly complex, a balance between abstraction and tight coupling must be found, and the production of a market-ready application must be reliable and deterministic.

Identifying patterns in source code can assist in this maintenance, such as in understanding dependencies between different files and/or libraries. Through the analysis of these patterns, it can be possible to enable code simplification through consolidation, identify candidates for refactoring, and/or enabling the update or migration of third-party dependencies in a more streamlined manner.

Prior approaches to identifying such code patterns generally comprise either labor-intensive discovery work, or custom scripts leveraging mainly on regular-expression-like code. Problems with these approaches include the former being time-consuming, while with the latter, custom scripts can be specific to the language used, and the scripts can usually rely on syntax and regular expressions only, to calculate the similarity, and are inaccurate.

The present techniques can address these problems with prior approaches by:
generating a graph from each source code file and its dependencies; and/or
augmenting the graph with flow information from a control flow graph (CFG).

This can result in a data source with improved accuracy for pattern identification, thus enhancing the accuracy of similarity techniques and other applications using that data.

Some prior approaches have a problem relating to an inability to represent the execution flow within each file, use it to get new insights from the overall dependency graph, and enable more efficient code pattern matching, code summarization, etc.

One of these problems is the inability to represent the execution flow within each file, use it to get new insights from the overall dependency graph, and enable more efficient code pattern matching, code summarization, etc.

### Example Architectures, etc

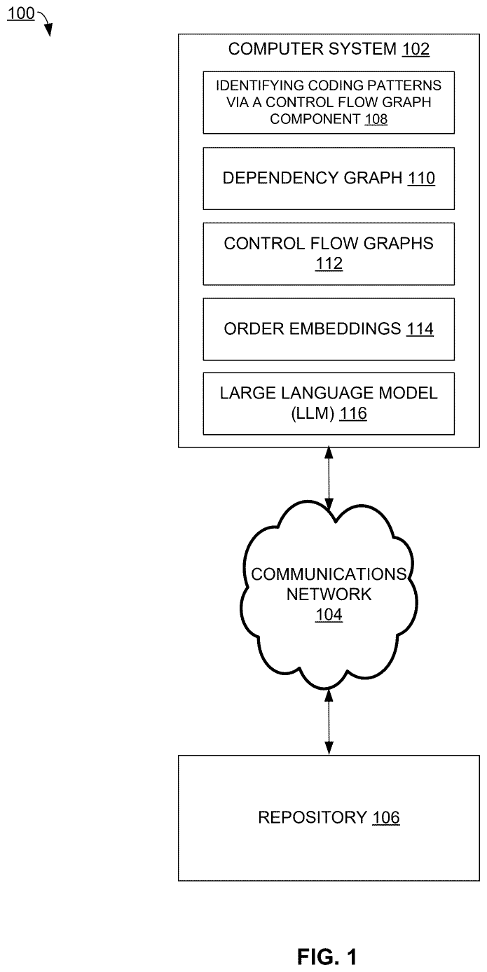

FIG. 1 illustrates an example system architecture 100 that can facilitate identifying coding patterns via a control flow graph, in accordance with an embodiment of this disclosure.

System architecture 100 comprises computer system 102, communications network 104, and repository 106. In turn, computer system 102 comprises identifying coding patterns via a control flow graph component 108, dependency graph 110, control flow graphs 112, order embeddings 114, and large language model (LLM) 116.

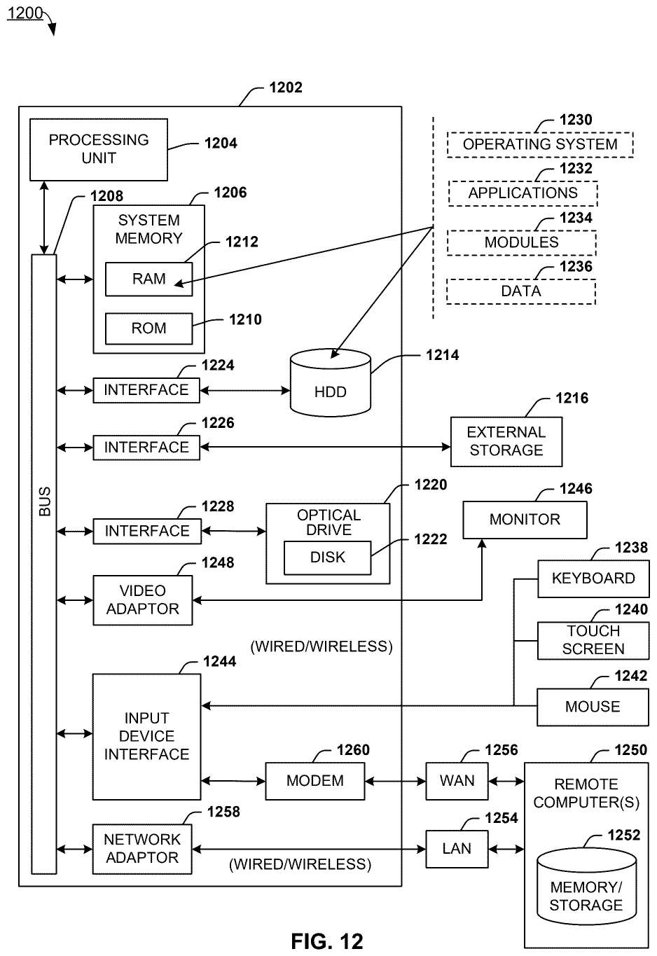

Each of computer system 102 and/or repository 106 can be implemented with part(s) of computing environment 1200 of FIG. 12. Communications network 104 can comprise a computer communications network, such as the Internet.

Repository 106 can store uncompiled computer code. Identifying coding patterns via a control flow graph component 108 can access this computer code, and from it, create dependency graph 110, control flow graphs 112, and order embeddings 114. Then, this information can be used in conjunction with LLM 116 to form a RAG. Inquiries to the RAG can be made, such as the inquiries described herein, and an output can comprise information about the computer code.

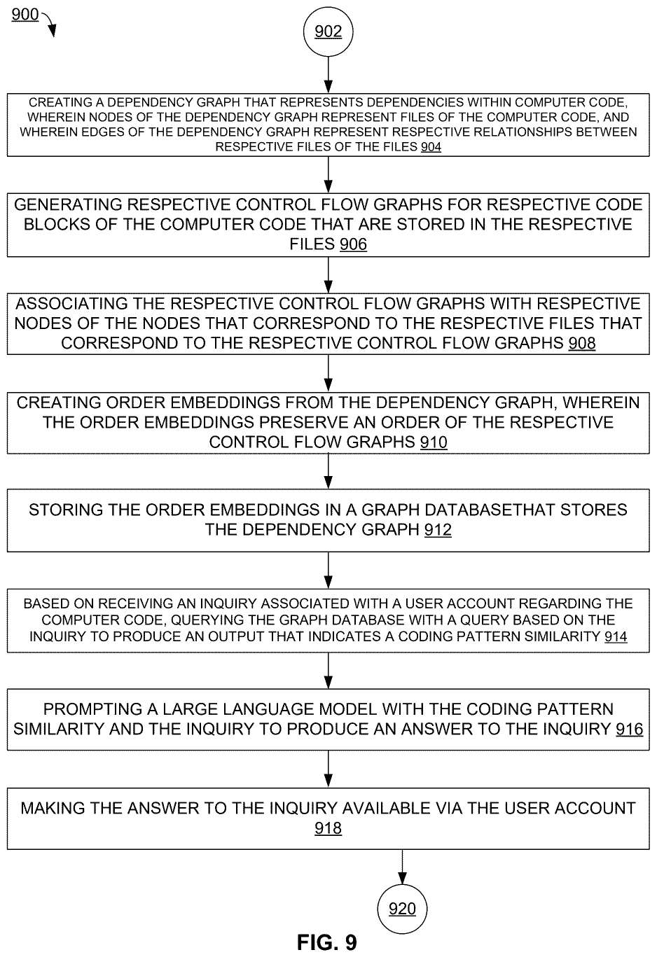

In some examples, identifying coding patterns via a control flow graph component 108 can implement part(s) of the process flows of FIGS. 9-11 to implement identifying coding patterns via a control flow graph.

It can be appreciated that system architecture 100 is one example system architecture for identifying coding patterns via a control flow graph, and that there can be other system architectures that facilitate identifying coding patterns via a control flow graph.

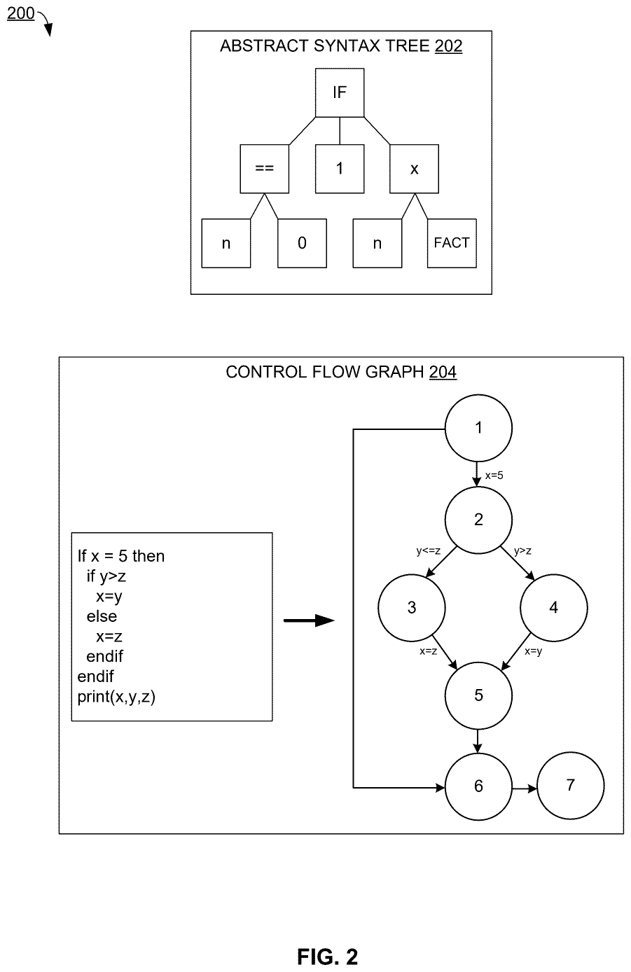

FIG. 2 illustrates an example 200 of an abstract syntax tree and a control flow graph, and that can facilitate identifying coding patterns via a control flow graph, in accordance with an embodiment of this disclosure. In some examples, part(s) of example 200 can be used by part(s) of system architecture 100 of FIG. 1 to facilitate identifying coding patterns via a control flow graph.

Example 200 comprises abstract syntax tree 202 and control flow graph 204.

An abstract syntax tree (AST) generally represents the hierarchical syntactic structure of the source code. An AST can be structured as a tree where constructs in the source code (expressions, statements, and declarations) are represented as nodes, and their relationships are presented as edges. An AST can be used in parsing, syntax analysis, and to understand the structure of the code.

A control flow graph (CFG) can represent the flow control within a program. A CFG can be structured a directed graph where code blocks are represented as nodes and flow paths are represented by edges. A CFG can be used in analysis and optimization of an execution flow within a software program.

Differences between an AST and a CFG can generally be as follows. An AST generally represents a syntactic structure while a CFG generally represents code blocks. An AST generally focuses on syntax and structure of the code, while a CFG generally focuses on execution paths and control flow. An AST is generally used for parsing and syntax analysis, while a CFG is generally used for analysis and optimization. Additionally, in contrast to an AST, a CFG can generally encapsulate the info per each basic code block.

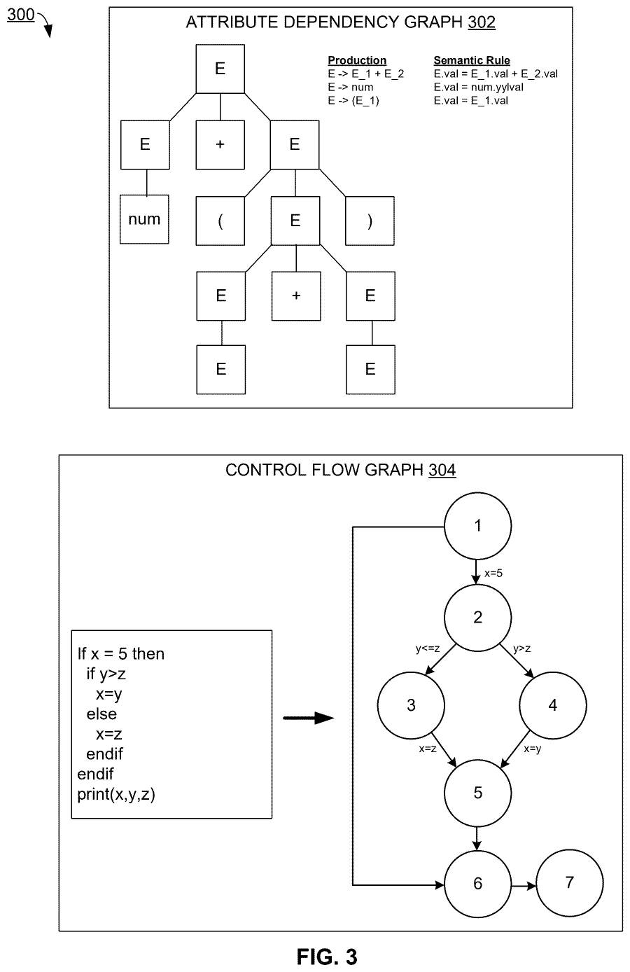

FIG. 3 illustrates an example 300 of an attribute dependency graph and a control flow graph, and that can facilitate identifying coding patterns via a control flow graph, in accordance with an embodiment of this disclosure. In some examples, part(s) of example 300 can be used by part(s) of system architecture 100 of FIG. 1 to facilitate identifying coding patterns via a control flow graph.

Example 300 comprises attribute dependency graph 302 and control flow graph 304.

An attribute dependency graph (ADG) can represent the dependencies among attributes in a system. In an ADG, each node represents an attribute or a design variable, and directed edges represent the dependency of one attribute on another. An ADG can be used in systems design and product development to help understanding the cause-and-effect relationships in complex systems.

Differences between an ADG and a CFG can be as follows. An ADG can represent attribute dependencies and causal relationships, while a CDG represents code blocks. An ADG can focus on dependencies in various systems, while a CDG focuses on execution paths and control flow. An ADG can be used for systems engineering and product design contexts, while a CDG can be used for analysis and optimization.

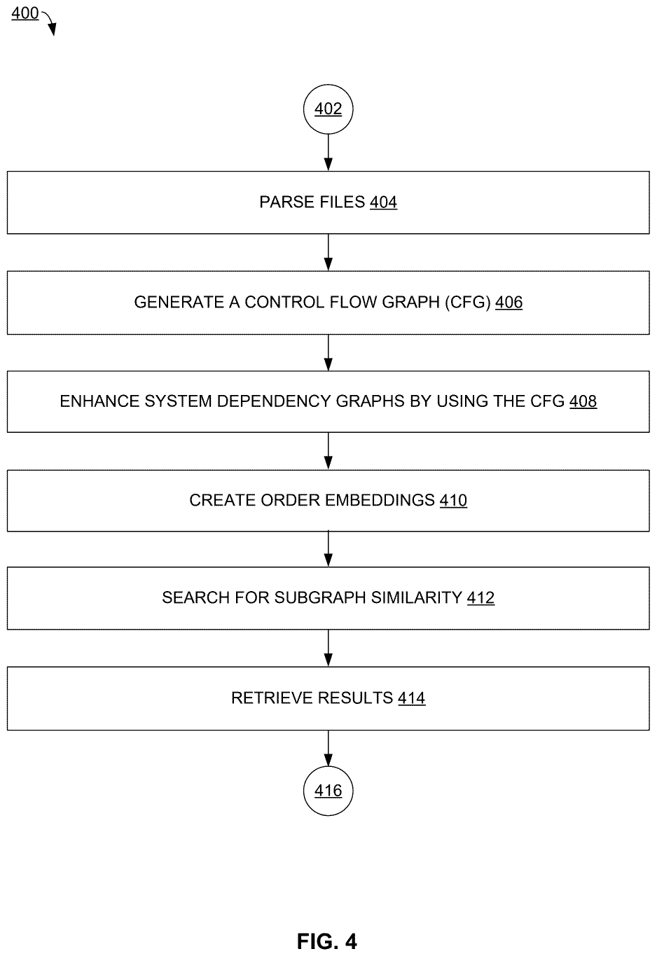

FIG. 4 illustrates an example process flow 400 that can facilitate identifying coding patterns via a control flow graph, in accordance with an embodiment of this disclosure. In some examples, one or more embodiments of process flow 400 can be implemented by identifying coding patterns via a control flow graph component 108 of FIG. 1, or computing environment 1200 of FIG. 12.

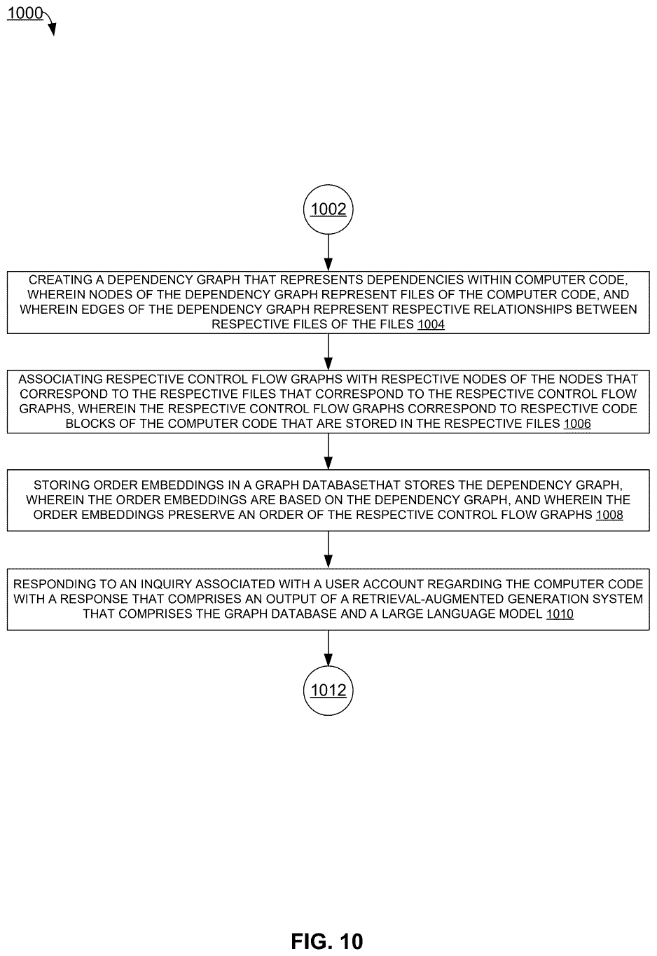

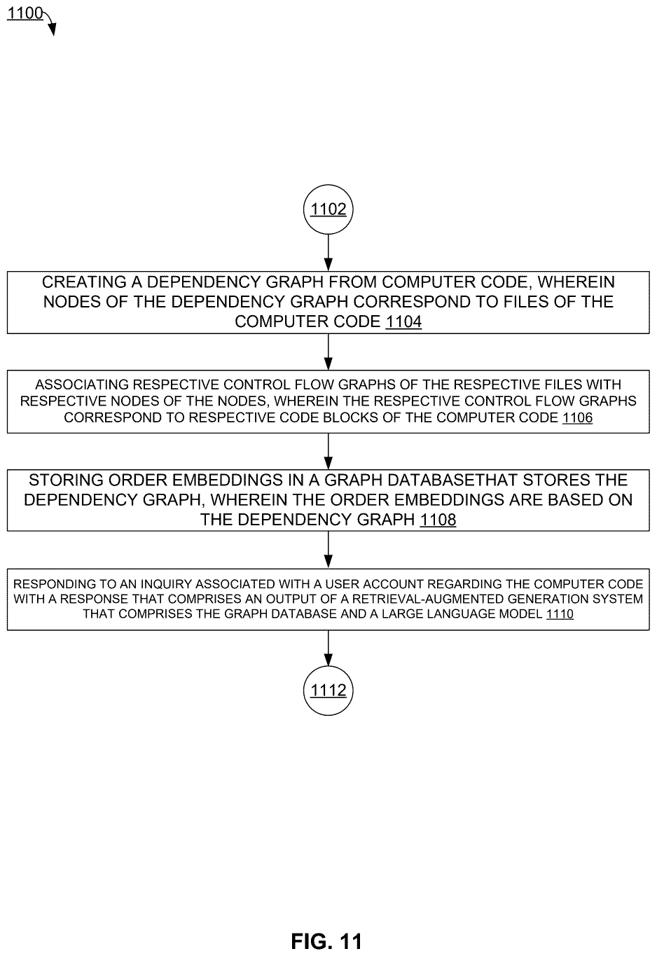

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 900 of FIG. 9, process flow 1000 of FIG. 10, and/or process flow 1100 of FIG. 11.

Process flow 400 begins with 402, and moves to 404.

Consider an example with a complex system and a dependency graph identifying the dependencies across subsystems, services and files. The present techniques can be implemented to:
Parse files 404 and identify composing functions and code: parsing can be done leveraging tools like a parsing framework and library;
Generate a control flow graph (CFG) 406 using tools like a control flow analysis tool.
Enhance system dependency graphs by using the CFG 408: the CFG created in operation 406 can be appended to the system dependency graph provided as a prerequisite, taking care of cross dependencies.
Create order embeddings 410: Order embeddings can comprise a kind of monotone function that map elements from one partially ordered set to another while preserving the order relationships. This means that, if one element is less than or equal to another in the original set, this relationship can be maintained in the embedded set. The order can be provided by the CFG.
Search for subgraph similarity 412 by using subgraph matching techniques that leverage the properties of order embeddings to improve their accuracy and runtime performance. Examples of such techniques can include graphical neural network (GNN)-based path dominance.
Retrieve results 414.
   Now, independently from the programming language of the source code, coding patterns similarity can be identified querying the graph.
   Order embeddings can be leveraged to fuel a recommender (e.g., to provide recommendations about impact of code changes, code migration order, etc.)
   Etc.

After 414, process flow 400 moves to 416, where process flow 400 ends.

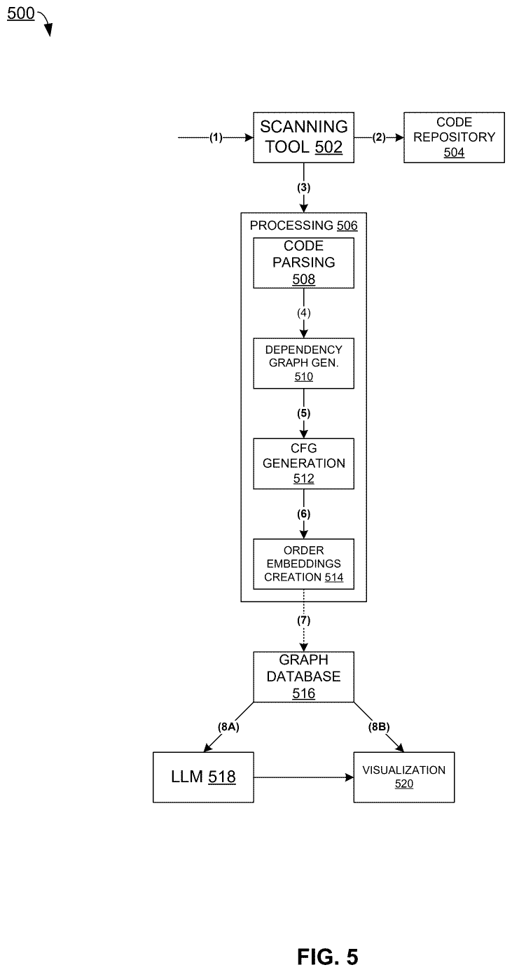

FIG. 5 illustrates an example 500 that can facilitate identifying coding patterns via a control flow graph, in accordance with an embodiment of this disclosure. In some examples, part(s) of example 500 can be used by part(s) of system architecture 100 of FIG. 1 to facilitate identifying coding patterns via a control flow graph.

Example 500 comprises the following components:
Scanning tool 502: An application/service that scans a code repository (e.g., upon request from the user) and generates a dependency graph enhanced by CFGs.
Code repository 504: a storage location where software code is kept, managed, and tracked.
Processing 506: this can include the processing within the scanning tool and can be depicted here to illustrate macro-steps involved in the processing stage.
   Code parsing 508: parses files from the code repository and creates appropriate nodes and relationships objects.
   Dependency graph generation 510: leverages the code parsing to generate a dependency graph with files as nodes and their relationships as edges.
   CFG generation 512: leverage tools to identify control flow generation graphs. It can also the CFG created to the existing dependency graph.
   Order embeddings creation 514: Order embeddings comprise a kind of monotone function that map elements from one partially ordered set to another while preserving the order relationships. This can mean that, if one element is less than or equal to another in the original set, this relationship is maintained in the embedded set. In the present scenario, the order can be provided by the CFG.
Graph database 516: A type of NoSQL database designed to represent and store data in a graph structure.
Large Language Model (LLM) 518: A type of artificial intelligence (AI) that is trained on text data to understand and generate human-like language.
Visualization 520: visualization tools like dashboards that leverage the GraphDB.

In example 500, the following labeled actions occur:
1. The scanning tool is initiated (e.g., in response to user input data).
2. The scanning tool fetches and starts scanning the relevant repository.
3. The code gets parsed.
4. A dependency graph is created with nodes and edges being added to it. Nodes can represent files, and edges can represent the relationships among the files.
5. Control flow graphs can be generated for code blocks in each file, and the CFGs are added to the dependency graph.
6. Order embeddings (preserving the CFG order) are created for the graph.
7. The graph is added to the Graph DB (this can happen as part of the processing, and this step can be included to represent the flow.)
8. Query stage:
   a) The GraphDB is used for retrieval augmented generation (RAG) to enhance the context for the LLM.
   b) The GraphDB is queried by dashboards, application programming interfaces (APIs), etc.

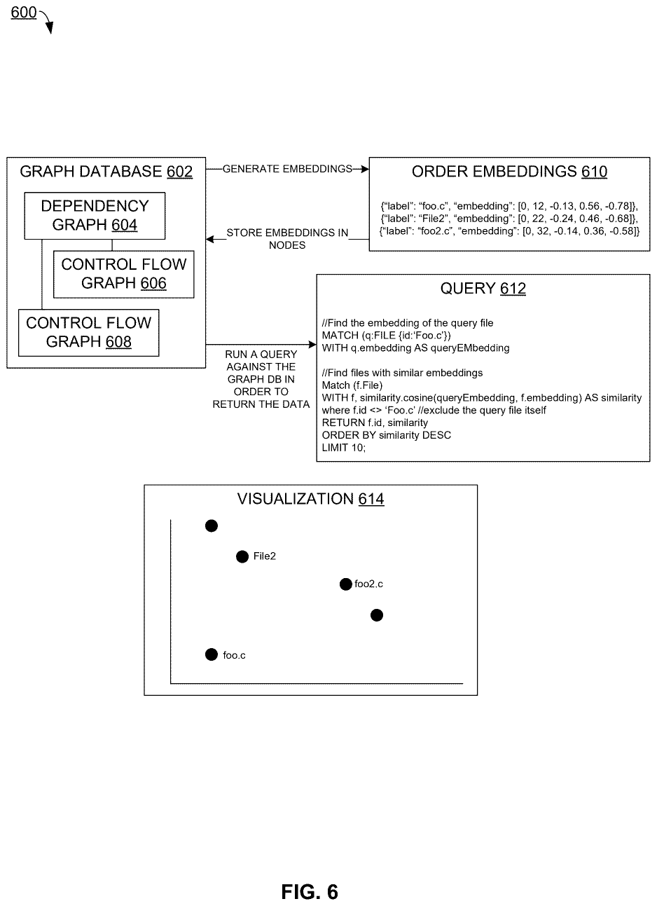

FIG. 6 illustrates another example 600 that can facilitate identifying coding patterns via a control flow graph, in accordance with an embodiment of this disclosure. In some examples, part(s) of example 600 can be used by part(s) of system architecture 100 of FIG. 1 to facilitate identifying coding patterns via a control flow graph.

Example 600 comprises graph database 602, dependency graph 604, control flow graph 606, control flow graph 608, order embeddings 610, query 612, and visualization 614.

With respect to order embeddings 610, order embeddings can comprise a kind of monotone function that maps elements from one partially ordered set to another while preserving the order relationships. This can mean that, if one element is less than or equal to another in the original set, this relationship is maintained in the embedded set. The order of the order embeddings can be provided by the CFG.

With respect to query 612, the query can determine a cosine similarity between the embedding of a given file and other files, then returns the most similar files. Each file node can have an embedding property stored in it.

With respect to visualization 614, each point represents a file embedding, and the labels help identify each point. The axes represent reduced dimensions that preserve the order of the higher-dimensional data. It can be that the axes do not have a specific meaning, but area used to position similar points closer together.

Given a complex code base, there can be several modules/libraries that depend on each other.

Following the described process, the user can trigger the scanning tool, which parses the code and creates a dependency graph. For clarity, this can be divided into two levels:
Level 1 (service/application), where each node is a software component such as a shared library, and each edge is a relationship between components.
Level 2 (files/modules) maps the files within each component, where each file is a node and each edge is a relationship (e.g. library X depends on the subcomponent Y).

These files are parsed, and for each file a CFG is created can be referred to as level 3. Then these CFGs can be attached (creating relevant relationships) to each file in level 2.

Order embeddings can be produced by running query matching.

In a graph database, this can include steps like:
Load graph data.
Project the graph: create a projection, which can comprise simplifying a graph while preserving meaningful relationships within the graph. This step can involve defining which nodes and relationships to include in the analysis.
Run the embedding algorithm to generate embeddings.
Store the generated embeddings into the nodes in the graph database.
Use embeddings for ML tasks.

Now queries can be run that leverage embeddings to fuel a recommender and/or answering questions like, What groups of similar coding patterns are there, and what do they look like? What functions are leveraging a specific shared library? What functions/components would be impacted by my change? What would be the impact of removing specific functions or libraries from the code base? What would be the impact of a given code change?

The following examples illustrate what information can be queried from CFG-enhanced graphs.

A first scenario involves identifying coding patterns in a large code base. A platform can be migrated from a first operating system (OS) to a second OS. The present techniques can answer queries such as:
What groups of similar coding patterns are there, and what do they look like?
What functions are leveraging a first operating system-specific API?
What functions/components would be impacted by the change?

A second scenario involves security vulnerability identification. A security analyst is reviewing code to identify the impact of a given vulnerability. The present techniques can answer queries such as:
Where are such vulnerabilities located, and what is their impact from a code point of view?
Are there similar vulnerabilities in the code, and what do they look like?

A third scenario involves automatic source code summarization (ASCS). There can be a desire to learn what a piece of code does. The present techniques can facilitate things such as:
Improving the semantic extraction stage by looking into the code path execution, leading to better matching.
Increasing accuracy in the identification of code achieving similar functionality.

A fourth scenario involves impact analysis. The present techniques can answer queries such as:
Which parts of the code can be reached from a given point?
What would be the impact of removing specific functions or libraries from the code base?
What would be the impact of a given code change?

A fifth scenario involves migration recommendation. There can be desire to identify macro steps to migrate a platform based on FreeBSD to Linux. The present techniques can answer queries such as:
What module/libraries should be migrated first? Why?
What is the impact of such migration?
How can the code be simplified, reducing redundancy?

It can be that a dependency graph is not sufficient to address these matters. While dependency graphs can be helpful in understanding the dependencies across files, modules, build processes, etc., it can be that they cannot provide the control flow within a file, which can be used in processes like security vulnerability identification, dead code identification, duplicate code identification, performance optimization, program verification, automation testing, etc.

The present technique can facilitate a language-agnostic way to identify coding patterns similarity by shaping source code files (e.g., files in .c, .java, py, makefile, etc..) in a graph and augmenting them with CFG details. The present techniques can leverage a CFG along with dependency graph, to fuel a recommender (e.g. to provide recommendations about impact of code changes, code migration order, etc . . . ).

The present techniques can be used to augment the semantic extraction phase of automatic source code summarization (ASCS) with CFG details, leading to better code summarization relative to prior approaches.

The present techniques can be language agnostic, offer—relative to prior approaches—improved accuracy for AI-based approaches to large codebase maintenance, and facilitate impact analysis.

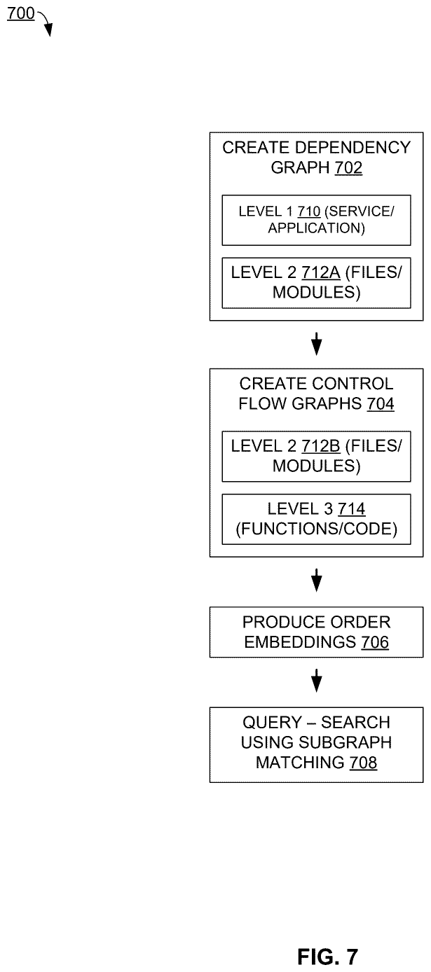

FIG. 7 illustrates another example 700 that can facilitate identifying coding patterns via a control flow graph, in accordance with an embodiment of this disclosure. In some examples, part(s) of example 700 can be used by part(s) of system architecture 100 of FIG. 1 to facilitate identifying coding patterns via a control flow graph.

Example 700 comprises create dependency graph 702, create control flow graphs 704, produce order embeddings 706, query—search using subgraph matching 708, Level 1 710 (service/application), Level 2 712A (files/modules), Level 2 712B (files/modules), and Level 3 714 (functions/code).

In example 700, the dependency graph is based on multiple microservices. Creating control flow graphs comprises parsing files in Level 2 and creating CFGs that will enhance the current dependency graph in the form of subgraphs, and can constitute Level 3.

Order embeddings can comprise a form of a monotone function that maps elements from one partially-ordered set to another while preserving the order relationships. This can mean that, if one element is less than or equal to another in the original set, this relationship can be maintained in the embedded set. In example 700, the order is provided by the control flow graph.

The query stage can use subgraph matching techniques that leverage the properties of order embeddings to improve an accuracy and runtime performance of subgraph matching tasks.

The following example of implementing the present techniques relates to a microservice architecture.

There is an ecosystem for an online shop, comprising by many microservices, some of them being a user service, an order service, a product service, a shopping cart service, databases, etc. The services interact with each other.

Following the described process, a user can trigger the scanning tool, which parses the code and creates a dependency graph, which can be divided into two logical levels:
Level 1 (service/application) where each node is a service (e.g., shopping service) and each edge is a relationship between services, (e.g., user>PLACES>order).
Level 2 (files/modules) maps the files within each service where each file is a node (e.g., the shopping cart service has files Item.java and Cart.java), and each edge is a relationship (e.g., the shopping cart service HAS_FILE Cart.java, or Item.java CONTAINED_IN Cart.java).

These files are parsed, and for each file, a CFG is created that can be referred to as level 3. Then the respective CFGs are attached (creating relevant relationships) to the respective files in level 2.

Order embeddings are produced. This can comprise steps such as:
Load graph data.
Project the graph: create a projection. This step can involve defining which nodes and relationships to include in the analysis.
Run the embedding algorithm to generate embeddings.
Store the generated embeddings into the nodes in a graph database.
Use embeddings for ML tasks.

Now queries can be run that leverage embeddings to fuel a recommender and/or answering questions like: What groups of similar coding patterns are there, and what do they look like? What functions are leveraging a specific Java library? What functions/components would be impacted by this change? What would be the impact of removing specific functions or libraries from the code base? What would be the impact of a given code change?

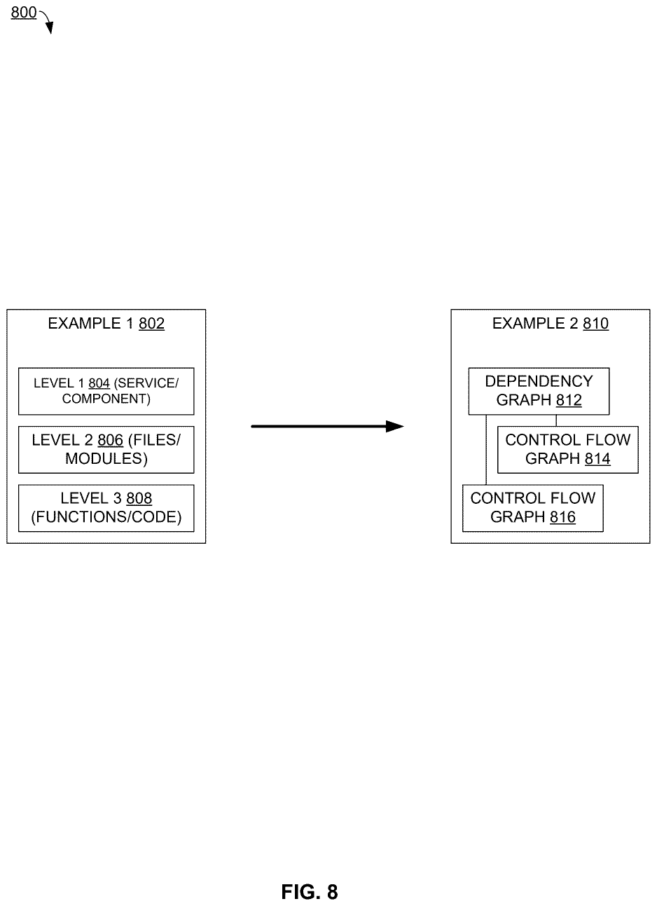

FIG. 8 illustrates another example 800 that can facilitate identifying coding patterns via a control flow graph, in accordance with an embodiment of this disclosure. In some examples, part(s) of example 800 can be used by part(s) of system architecture 100 of FIG. 1 to facilitate identifying coding patterns via a control flow graph.

Example 800 comprises example 1 802, level 1 804 (service/component), level 2 806 (files/modules), level 3 808 (functions/code), example 2 810, dependency graph 812, control flow graph 814, and control flow graph 816.

Level 1 maps dependencies across services, and can be used to answer questions like, “what service is leveraging a database?”

Level 2 maps dependencies across files. It can be used to answer questions does, “What libraries/headers/etc. does a particular file depend on, and what depends on this particular file?”

Level 3 maps dependencies within code. This level can allow, for example, identifying coding patterns and flow. This level can be used to determine what the impact of a change would be, in terms of files affected. In some examples, a parser used to extract dependencies in Level 1 and Level 2 can be used to map Level 3 dependencies.

Example 800 illustrates dividing the dependency map generation into levels. In this example, the CFG for file5.py is represented as Level 3. This means that a process would pick every leaf of type file and create a CFG for it. As done for previous levels, the analysis could indicate what the other dependencies there are.

In some examples, it can be that, while a CFG is being built, a dependent CFG might not have been created yet. To address this, a phantom node for that dependency can be created in the graph, which can serve as a placeholder. The phantom node can be replaced with an actual node when the other CFG is created.

CFGs can present advantages over call graphs, such as:
Detailed intraprocedural analysis with complete view of the flow within a single function or procedure (which can help with analysis of branches, loops, etc., and to identify what can be pruned from the graph).
Detailed path analysis for execution paths (enabling leveraging graph theory for testing purposes—e.g., to determine whether all the paths are covered).
Granular level of control flow representation compared to call graphs that show just relationships among functions.

### Example Process Flows

FIG. 9 illustrates an example process flow 900 that can facilitate identifying coding patterns via a control flow graph, in accordance with an embodiment of this disclosure. In some examples, one or more embodiments of process flow 900 can be implemented by identifying coding patterns via a control flow graph component 108 of FIG. 1, or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 1000 of FIG. 10, and/or process flow 1100 of FIG. 11.

Process flow 900 begins with 902, and moves to operation 904.

Operation 904 depicts creating a dependency graph that represents dependencies within computer code, wherein nodes of the dependency graph represent files of the computer code, and wherein edges of the dependency graph represent respective relationships between respective files of the files. Using the example of FIG. 1, the computer code can be accessed from repository 106, and the dependency graph can be similar to dependency graph 110.

In some examples, operation 904 comprises accessing the computer code via a repository in which the computer code is stored before the performing of the creating of the dependency graph that represents dependencies within the computer code. In some examples, the accessing is performed based on receiving user input data. That is, this can be performed by a scanning tool that initiates this process based on user input, and the scanning tool can scan the relevant repository for the computer code.

After operation 904, process flow 900 moves to operation 906.

Operation 906 depicts generating respective control flow graphs for respective code blocks of the computer code that are stored in the respective files. Continuing with the example of FIG. 1, these control flow graphs can be similar to control flow graphs 112.

In some examples, the nodes are first nodes, the edges are first edges, the respective control flow graphs for the respective code blocks comprise respective directed graphs, respective second nodes of the respective directed graphs correspond to the respective code blocks, and respective second edges of the respective directed graphs correspond to respective flow paths between the respective code blocks. That is, a CFG can represent a control flow within computer code. It can comprise a directed graph where code blocks are represented as nodes, and flow paths are represented as edges.

In some examples, the nodes are first nodes, the edges are first edges, the relationships are first relationships, respective second nodes of the graph database correspond to the order embeddings, and respective second edges of the graph database represent respective second relationships between the respective control flow graphs. That is, edges of a graph database can represent relationships, such as between files, between files and corresponding CFGs, and between portions of code in CFGs.

After operation 906, process flow 900 moves to operation 908.

Operation 908 depicts associating the respective control flow graphs with respective nodes of the nodes that correspond to the respective files that correspond to the respective control flow graphs. That is, the nodes can represent particular files, and the control flow graphs can be taken from particular files. The associating can be a matching of these files.

Using a three-level representation, at Level 1, nodes are services. At Level 2, nodes are files. At Level 3, nodes are CFGs and may or may not be linked to other CFGs.

After operation 908, process flow 900 moves to operation 910.

Operation 910 depicts creating order embeddings from the dependency graph, wherein the order embeddings preserve an order of the respective control flow graphs. In some examples, these order embeddings can be similar to order embeddings 114 of FIG. 1.

The order embeddings can be generated and stored in the nodes of the dependency graph. In an example, a user wants to port code from platform A to platform B. As the user realizes that a given code pattern cannot be used anymore (e.g., for security reasons, because of missing capabilities, changed libraries, infra, etc . . . ), the user wants to identify where this pattern is used in the code, and it can be that searching in the code is not feasible because of the sheer amount of code. Moreover, the use of a library might be alright, as long as the overall code pattern does not fall into the one that that the user is looking for.

Code patterns can be found by leveraging the fact that coding patterns with similar content and the same (or similar) code flow can be translated in embeddings (which can comprise points on a multidimensional plane), which are close to each other. Given a code pattern in input, a database query leveraging embeddings can find similarity in the code.

In some examples, the creating of the order embeddings comprises applying a monotone function to the dependency graph, wherein the monotone function maps elements from a first partially ordered set to a second partially ordered set, wherein the second partially ordered set preserves an order relationship of the first partially ordered set. That is, order embeddings can comprise a kind of monotone function that map elements from one partially ordered set to another while preserving the order relationships. This can mean that, if one element is less than or equal to another in the original set, this relationship is maintained in the embedded set. The order can be provided by the CFGs.

After operation 910, process flow 900 moves to operation 912.

Operation 912 depicts storing the order embeddings in a graph database that stores the dependency graph. That is, a graph database can store the dependency graph, the CFGs, and the order embeddings.

After operation 912, process flow 900 moves to operation 914.

Operation 914 depicts, based on receiving an inquiry associated with a user account regarding the computer code, querying the graph database with a query based on the inquiry to produce an output that indicates a coding pattern similarity.

After operation 914, process flow 900 moves to operation 916.

Operation 916 depicts prompting a large language model with the coding pattern similarity and the inquiry to produce an answer to the inquiry. This LLM can be similar to LLM 116 of FIG. 1.

In some examples, the graph database and the large language model comprise a retrieval-augmented generation system. That is, a RAG can be used, where the RAG comprises the LLM and the graph database.

After operation 916, process flow 900 moves to operation 918.

Operation 918 depicts making the answer to the inquiry available via the user account.

After operation 918, process flow 900 moves to 920, where process flow 900 ends.

FIG. 10 illustrates another example process flow 1000 that can facilitate identifying coding patterns via a control flow graph, in accordance with an embodiment of this disclosure. In some examples, one or more embodiments of process flow 1000 can be implemented by identifying coding patterns via a control flow graph component 108 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 400 of FIG. 4, process flow 900 of FIG. 9, and/or process flow 1100 of FIG. 11.

Process flow 1000 begins with 1002, and moves to operation 1004.

Operation 1004 depicts creating a dependency graph that represents dependencies within computer code, wherein nodes of the dependency graph represent files of the computer code, and wherein edges of the dependency graph represent respective relationships between respective files of the files. In some examples, operation 1004 can be implemented in a similar manner as operation 904 of FIG. 9.

In some examples, the nodes of the dependency graph correspond to software components of the computer code, at least one node of the nodes corresponds to two of the files, and the edges of the dependency graph correspond to relationships between the software components.

In some examples, the nodes are first nodes, the edges are first edges, a first level of the dependency graph comprises the first nodes and the first edges, a second level of the dependency graph comprises second nodes and second edges, the second nodes correspond to the files, and the second edges correspond to relationships between the files.

That is, code can be parsed to create a dependency graph that can comprise two logical levels. Level 1 can comprise a service/application level, where each node is a software component (such as a library), and each edge is a relationship between components. Level 2 can comprise a file/module level, which maps files within each component, where each file is a node and each edge is a relationship between files (e.g., library dm depends on the subcomponent named dm_foo).

After operation 1004, process flow 1000 moves to operation 1006.

Operation 1006 depicts associating respective control flow graphs with respective nodes of the nodes that correspond to the respective files that correspond to the respective control flow graphs, wherein the respective control flow graphs correspond to respective code blocks of the computer code that are stored in the respective files. In some examples, operation 1004 can be implemented in a similar manner as operations 906-908 of FIG. 9.

In some examples, the dependency graph comprises a third level, and wherein the third level comprises the control flow graphs. Continuing with the multi-level logical representation of the dependency graph, control flow graphs can be considered to be Level 3, and they can be attached (e.g., creating relevant relationships) to files at Level 2.

After operation 1006, process flow 1000 moves to operation 1008.

Operation 1008 depicts storing order embeddings in a graph database that stores the dependency graph, wherein the order embeddings are based on the dependency graph, and wherein the order embeddings preserve an order of the respective control flow graphs. In some examples, operation 1008 can be implemented in a similar manner as operations 910-912 of FIG. 9.

In some examples, respective order embeddings of the order embeddings comprise respective labels that identify the respective files that correspond to the respective order embeddings, and the respective order embeddings comprise respective embeddings that comprise respective vectors of respective numeric values. The order embeddings can be similar to order embeddings 610 of FIG. 6.

After operation 1008, process flow 1000 moves to operation 1010.

Operation 1010 depicts responding to an inquiry associated with a user account regarding the computer code with a response that comprises an output of a retrieval-augmented generation system that comprises the graph database and a large language model. In some examples, operation 1010 can be implemented in a similar manner as operations 914-918 of FIG. 9.

In some examples, the response comprises a visualization of the order embeddings in a space having a first number of first dimensions, the order embeddings have a second number of second dimensions, the first number is less than the second number, and the first dimensions satisfy an order-and-structure criterion with respect to the second dimensions. The visualization can be similar to visualization 614 of FIG. 6.

In some examples, the computer code is first computer code expressed in a first programming language, the response is based on a comparison between the first computer code and second computer code expressed in a second programming language, and the first programming language differs from the second programming language. That is, the present techniques can provide a language-agnostic way to identify similar coding patterns by shaping source code files in a graph and augmenting the graph with CFG details.

After operation 1010, process flow 1000 moves to 1012, where process flow 1000 ends.

FIG. 11 illustrates another example process flow 1100 that can facilitate identifying coding patterns via a control flow graph, in accordance with an embodiment of this disclosure. In some examples, one or more embodiments of process flow 1100 can be implemented by identifying coding patterns via a control flow graph component 108 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 400 of FIG. 4, process flow 900 of FIG. 9, and/or process flow 1000 of FIG. 10.

Process flow 1100 begins with 1102, and moves to operation 1104.

Operation 1104 depicts creating a dependency graph from computer code, wherein nodes of the dependency graph correspond to files of the computer code. In some examples, operation 1104 can be implemented in a similar manner as operation 904 of FIG. 9.

After operation 1104, process flow 1000 moves to operation 1106.

Operation 1106 depicts associating respective control flow graphs of the respective files with respective nodes of the nodes, wherein the respective control flow graphs correspond to respective code blocks of the computer code. In some examples, operation 1106 can be implemented in a similar manner as operations 906-908 of FIG. 9.

After operation 1106, process flow 1100 moves to operation 1108.

Operation 1108 depicts storing order embeddings in a graph database that stores the dependency graph, wherein the order embeddings are based on the dependency graph. In some examples, operation 1106 can be implemented in a similar manner as operations 910-912 of FIG. 9.

After operation 1108, process flow 1100 moves to operation 1110.

Operation 1110 depicts responding to an inquiry associated with a user account regarding the computer code with a response that comprises an output of a retrieval-augmented generation system that comprises the graph database and a large language model. In some examples, operation 1106 can be implemented in a similar manner as operations 914-918 of FIG. 9.

In some examples, the response identifies a recommendation about an impact of a change to the computer code, a migration order for the computer code, a coding pattern of the computer code, a security vulnerability of the computer code, a summarization of the computer code, a duplicate within the computer code, a performance optimization of the computer code, an automation testing of the computer code, a program verification of the computer code, or a dead code identification of the computer code. That is, the present techniques can be implemented to answer various questions about computer code.

In some examples, the inquiry indicates a first inquiry regarding coding patterns of the computer code, a second inquiry regarding functions of the computer code leveraging a code library, a third inquiry regarding a first impact of a change to the computer code, or a fourth inquiry regarding a second impact of removing part of the computer code. That is, the present techniques can be implemented to answer various questions about computer code.

In some examples, the output of the retrieval-augmented generation system is based on performing a query on the retrieval-augmented generation system that is processed based on performing a similarity search between at least part of the query and data of the graph database. In some examples, the similarity search is based on a cosine similarity criterion. In some examples, the similarity search returns a defined number of results, and wherein results of the defined number of results is ranked according to a similarity criterion. This can be similar to query 612 of FIG. 6.

After operation 1110, process flow 1100 moves to 1112, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of computer system 102, and/or repository 106.

In some examples, computing environment 1200 can implement one or more embodiments of the process flows of FIGS. 9-11 to facilitate identifying coding patterns via a control flow graph.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the . NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
creating a dependency graph that represents dependencies within computer code, wherein nodes of the dependency graph represent files of the computer code, and wherein edges of the dependency graph represent respective relationships between respective files of the files;
generating respective control flow graphs for respective code blocks of the computer code that are stored in the respective files;
for the respective files that correspond to the respective control flow graphs, associating the respective control flow graphs with respective nodes of the nodes that correspond to the respective files;
creating order embeddings from the dependency graph, wherein the order embeddings preserve an order of the respective control flow graphs;
storing the order embeddings in a graph database that stores the dependency graph;
based on receiving an inquiry associated with a user account regarding the computer code, querying the graph database with a query based on the inquiry to produce an output that indicates a coding pattern similarity;
prompting a large language model with the coding pattern similarity and the inquiry to produce an answer to the inquiry; and
making the answer to the inquiry available via the user account.

2. The system of claim 1, wherein the nodes are first nodes, wherein the edges are first edges, wherein the respective control flow graphs for the respective code blocks comprise respective directed graphs, wherein respective second nodes of the respective directed graphs correspond to the respective code blocks, and wherein respective second edges of the respective directed graphs correspond to respective flow paths between the respective code blocks.

3. The system of claim 1, wherein the creating of the order embeddings comprises:
applying a monotone function to the dependency graph, wherein the monotone function maps elements from a first partially ordered set to a second partially ordered set, wherein the second partially ordered set preserves an order relationship of the first partially ordered set.

4. The system of claim 1, wherein the nodes are first nodes, wherein the edges are first edges, wherein the relationships are first relationships, wherein respective second nodes of the graph database correspond to the order embeddings, and wherein respective second edges of the graph database represent respective second relationships between the respective control flow graphs.

5. The system of claim 1, wherein the graph database and the large language model comprise a retrieval-augmented generation system.

6. The system of claim 1, wherein the operations further comprise:
accessing the computer code via a repository in which the computer code is stored before the performing of the creating of the dependency graph that represents dependencies within the computer code.

7. The system of claim 6, wherein the accessing is performed based on receiving user input data.

8. A method, comprising:
creating, by a system comprising at least one processor, a dependency graph that represents dependencies within computer code, wherein nodes of the dependency graph represent files of the computer code, and wherein edges of the dependency graph represent respective relationships between respective files of the files;
associating, by the system, respective control flow graphs with respective nodes of the nodes that correspond to the respective files that correspond to the respective control flow graphs, wherein the respective control flow graphs correspond to respective code blocks of the computer code that are stored in the respective files;
storing, by the system, order embeddings in a graph database that stores the dependency graph, wherein the order embeddings are based on the dependency graph, and wherein the order embeddings preserve an order of the respective control flow graphs;
responding, by the system, to an inquiry associated with a user account regarding the computer code with a response that comprises an output of a retrieval-augmented generation system that comprises the graph database and a large language model.

9. The method of claim 8, wherein respective order embeddings of the order embeddings comprise respective labels that identify the respective files that correspond to the respective order embeddings, and wherein the respective order embeddings comprise respective embeddings that comprise respective vectors of respective numeric values.

10. The method of claim 8, wherein the response comprises a visualization of the order embeddings in a space having a first number of first dimensions, wherein the order embeddings have a second number of second dimensions, wherein the first number is less than the second number, and wherein the first dimensions satisfy an order-and-structure criterion with respect to the second dimensions.

11. The method of claim 8, wherein the nodes of the dependency graph correspond to software components of the computer code, wherein at least one node of the nodes corresponds to two of the files, and wherein the edges of the dependency graph correspond to relationships between the software components.

12. The method of claim 11, wherein the nodes are first nodes, wherein the edges are first edges, wherein a first level of the dependency graph comprises the first nodes and the first edges, wherein a second level of the dependency graph comprises second nodes and second edges, wherein the second nodes correspond to the files, and wherein the second edges correspond to relationships between the files.

13. The method of claim 11, wherein the dependency graph comprises a third level, and wherein the third level comprises the control flow graphs.

14. The method of claim 8, wherein the computer code is first computer code expressed in a first programming language, wherein the response is based on a comparison between the first computer code and second computer code expressed in a second programming language, and wherein the first programming language differs from the second programming language.

15. A non-transitory computer-readable medium comprising instructions that, in response to execution, cause a system comprising at least one processor to perform operations, comprising:
creating a dependency graph from computer code, wherein nodes of the dependency graph correspond to files of the computer code;
associating respective control flow graphs of the respective files with respective nodes of the nodes, wherein the respective control flow graphs correspond to respective code blocks of the computer code;
storing order embeddings in a graph database that stores the dependency graph, wherein the order embeddings are based on the dependency graph; and
responding to an inquiry associated with a user account regarding the computer code with a response that comprises an output of a retrieval-augmented generation system that comprises the graph database and a large language model.

16. The non-transitory computer-readable medium of claim 15, wherein the response identifies a recommendation about an impact of a change to the computer code, a migration order for the computer code, a coding pattern of the computer code, a security vulnerability of the computer code, a summarization of the computer code, a duplicate within the computer code, a performance optimization of the computer code, an automation testing of the computer code, a program verification of the computer code, or a dead code identification of the computer code.

17. The non-transitory computer-readable medium of claim 15, wherein the output of the retrieval-augmented generation system is based on performing a query on the retrieval-augmented generation system that is processed based on performing a similarity search between at least part of the query and data of the graph database.

18. The non-transitory computer-readable medium of claim 17, wherein the similarity search is based on a cosine similarity criterion.

19. The non-transitory computer-readable medium of claim 17, wherein the similarity search returns a defined number of results, and wherein results of the defined number of results is ranked according to a similarity criterion.

20. The non-transitory computer-readable medium of claim 15, wherein the inquiry indicates a first inquiry regarding coding patterns of the computer code, a second inquiry regarding functions of the computer code leveraging a code library, a third inquiry regarding a first impact of a change to the computer code, or a fourth inquiry regarding a second impact of removing part of the computer code.
